(19) United States
(12) Patent Application Publication
(10) Pub. No.: US 2005/0228697 A1
(43) Pub. Date: Oct. 13, 2005

(54) Examination appointment method and system, and server to be used for the same

(75) Inventor: Takeshi Funahashi, Kaisei-machi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/098,437

(22) Filed: Apr. 5, 2005

(30) Foreign Application Priority Data
Apr. 7, 2004 (JP) 2004-113366

(51) Int. Cl. G06F 17/60

(52) U.S. Cl. 705/2

(57) ABSTRACT

An examination appointment method that facilitates an operation of making an examination appointment from a clinic to a hospital for a patient to be examined in a hospital having a large-scale examination device. Further, practices such as examination and interpretation can be performed in cooperation. The method includes the steps of: retrieving a list data by a server when a list of examination devices is requested from a terminal of a clinic; transmitting to the server information representing a medical institution and a examination device designated in the list displayed in the terminal; generating appointment status data representing a calendar page including appointment frames relating to an appointment status and transmitting the appointment status data to the terminal; transmitting examination appointment information representing an appointment frame designated in the calendar page to the server; and making an examination appointment by storing the received examination appointment information.

### BACKGROUND OF THE INVENTION

1. Field of the Invention

The present invention relates to a method and a system for making appointment of examination at a medical institution having large-scale examination devices from clinics or the like so that a patient thereof can be examined in the medical institution. Further, the present invention relates to a server to be used for the examination appointment system.

2. Description of a Related Art

Conventionally, in medical institutions such as hospitals, medical diagnoses have been performed by using medical images obtained by medical imaging apparatuses utilizing radiation (X-ray, α-ray, β-ray, γ-ray, electron beam, ultraviolet light, etc.), ultrasonic wave, MR (magnetic resonance) and so on. Such medical images are required to be stored in order to know changes in medical conditions of patients, and required to be stored in a predetermined period by law. Accordingly, in the medical institutions, it is necessary to store a vast amount of medical images. Conventionally, films or the like, on which medical images are taken, have been stored, and thereby, securing of storage space, management work and retrieval work have imposed heavy burdens on the medical institutions.

In recent years, digitization of medical imaging apparatuses has been proceeding, and storage space can be reduced and management work and retrieval work can be saved by recording medical images as image data in optical disks, magnetic disks or the like. However, since one sheet of medical image is represented by a vast amount of image data, even if they are recorded in optical disks, a considerable number of optical disks are required to store the image data for the predetermined period.

Accordingly, a system for centrally managing medical images in a data center located apart from the medical institutions has been proposed. In the medical image central management system, image data obtained in plural medical institutions are centrally stored in a database server provided in the data center. Thereby, the necessity for the respective medical institutions to independently store recording media in which medical data have been recorded is eliminated and space or costs therefor can be reduced.

On the other hand, since medical institutions such as clinics and small hospitals can not possess expensive diagnostic devices from a business stand point, diagnoses using expensive diagnostic devices such as CT (computed tomography) device, MRI (magnetic resonance imaging) device, ES (endoscope) device and so on are performed in medical institutions such as large hospitals that posses expensive diagnostic devices. That is, in the case where a diagnosis using a diagnostic device, which a medical institution such as a clinic does not possess, is required for a patient visiting the medical institution, a doctor of the medical institution introduces the patient to another medical institution that possesses the diagnostic device to be used for the diagnosis and that is affiliated with the medical institution. Thereby, the diagnosis of the patient is performed in the introduced medical institution.

However, conventionally, the introduction of patients to medical institutions is performed by using telephones, facsimiles or the like. Further, an examination appointment at a medical institution, to which a patient is introduced, is performed by using a telephone or performed when the patient completes reception at the medical institution, and therefore, procedures until the diagnosis are complicated.

As a related technology, Japanese Patent Application Publication JP-P2001-265877A discloses a service method capable of easily rendering services such as examination appointment, image acquisition, diagnosis data acquisition, and CAD (computer aided diagnosis) processing (pages 1 and 6-9, and FIG. 1). In this service method, when a service center receives a request of service from a client terminal, it requests the client terminal to display a menu for receiving a hospital to be requested for the service, requests the client terminal to display a retrieval screen based on menu selection by the client, prompts the client to input an area, examination contents, a desired date, etc. from the retrieval screen, and receives the retrieval information. Then, the service center requests the client terminal to acquire and display the retrieval result, prompts the client to select a target hospital, creates and displays a schedule of the target hospital and hospital information based on the selection result and requests necessity of the appointment. Furthermore, the service center requests the client terminal to acquire and display the schedule, prompts the client to make a registration into the schedule and confirmation and, when the appointment is confirmed, receives the appointment, creates a schedule and requests the client terminal to acquire and display the appointment result.

Thereby, medical institutions having suitable diagnostic devices can be checked in clinics and small hospitals, and further, appropriate medical institutions can be introduced to the clinics and small hospitals. Further, information necessary for examination such as patient information and items desired to be retrieved can be sent conveniently, and examination appointments can be made easily. Furthermore, by setting option services as to whether image CAD analysis is required or not, whether a finding report is required or not, whether a diagnosis by a specialist is required or not, and whether an electronic report is required or not, services can be provided not only for examinations but also for various requests.

However, in this service method, there is a problem that, in the case where a medical institution that seems to be most appropriate is retrieved in the service center based on the area, the examination contents, the desired date, etc. inputted in the client terminal, the choices of medical institutions to be introduced is narrowed depending on the area. That is, the medical institution to be introduced should not be automatically determined on geometric conditions or the like but should be determined based on the patient's preference, the relation between the doctor who introduces the patient and the medical institution, or the like. However, according to the service method, the medical institution to be introduced is automatically determined on geometric conditions or the like. Accordingly, patient's demand such as preferences cannot be reflected, and further, the relation between the doctor who introduces the patient and the medical institution cannot be considered.

Furthermore, according to the service method, a medical institution is retrieved based on the examination contents, the preferred date, or the like, and then, the appointment status as to whether an appointment can be made or not is acquired as a retrieval result. Accordingly, in the case where the result that the appointment can not be made is acquired, it is necessary to repeat retrievals until the appointment can be made while re-inputting different preferred dates or the like. Therefore, the operation until the appointment becomes complicated, and sometimes it has almost no difference of the complication from the examination appointment by using telephones, facsimiles, or the like. Consequently, waiting time of a patient for examination appointment can not be reduced.

In addition to the examination appointment service, JP-P2001-265877A discloses an examination data/diagnosis image data acquisition service for acquiring examination data and diagnosis image data, and discloses that a patient can grasp statuses as to whether a series of examination is finished, a report is completed, and a report is submitted to a desired hospital. However, it does not disclose displaying progress statuses in the process in which the appointed examination is being performed.

Further, in JP-P2001-265877A, it is described that services such as the examination appointment service, the examination data/diagnosis image data acquisition service and an examination data analysis processing service are provided as a series of services. However, merely operations for receiving the services are integrated, and there is no linking and association between the individual services.

### SUMMARY OF THE INVENTION

The present invention has been achieved in view of the above-described problems. An object of the present invention is to provide an examination appointment method and system by which an operation of making an examination appointment from a clinic or the like to a medical institution for a patient to be examined in a medical institution having a large-scale examination device is facilitated, and practices such as examination and interpretation can be performed in cooperation. Further, another object of the present invention is to provide a server to be used in such system.

In order to achieve the objects, an examination appointment method according to the present invention is an examination appointment method to be used in an examination appointment system including a server installed in a data center, first terminals respectively installed in a plurality of examination request source medical institutions and connected to the server via a network, and second terminals respectively installed in a plurality of examination request destination medical institutions, which perform examinations intended for diagnosis in accordance with requests from the plurality of examination request source medical institutions and connected to the server via a network, and the method includes the steps of: storing list data, in which selected examination request destination medical institutions and examination devices installed therein are associated with each others with respect to each of the plurality of examination request source medical institutions, in a first database by the server; retrieving the list data associated with one of the plurality of examination request source medical institutions in the first database by the server when a list of examination devices installed in the examination request destination medical institutions selected by the examination request source medical institution is requested from a first terminal of the examination request source medical institution; transmitting the retrieved list data from the server to the first terminal; displaying in the first terminal the list of examination devices installed in the examination request destination medical institutions selected by the examination request source medical institution based on the received list data; transmitting from the first terminal to the server information representing an examination request destination medical institution and an examination device designated in the displayed list of examination devices; generating appointment status data in the server and transmitting the appointment status data to the first terminal, the appointment status data representing a calendar page including a plurality of appointment frames relating to appointment status of examinations employing the designated examination device in the designated examination request destination medical institution; displaying the calendar page including the plurality of appointment frames based on the received appointment status data in the first terminal; transmitting examination appointment information representing an appointment frame designated in the displayed calendar page from the first terminal to the server; and making an examination appointment by storing the received examination appointment information in a second database by the server.

Further, an examination appointment system according to the present invention is an examination appointment system including a server installed in a data center, first terminals respectively installed in a plurality of examination request source medical institutions and connected to the server via a network, and second terminals respectively installed in a plurality of examination request destination medical institutions, which perform examinations intended for diagnosis in accordance with requests from the plurality of examination request source medical institutions, and connected to the server via a network, and the system includes: a first terminal for making a request for a list of examination devices installed in the examination request destination medical institutions selected by one of the plurality of examination request source medical institutions to the server, displaying the list of examination devices installed in the examination request destination medical institutions selected by the examination request source medical institution based on the list data transmitted from the server, transmitting information representing an examination request destination medical institution and an examination device designated in the displayed list of examination devices to the server, displaying a calendar page including a plurality of appointment frames based on the appointment status data transmitted from the server and transmitting examination appointment information representing an appointment frame designated in the displayed calendar page to the server; and a server for storing list data, in which selected examination request destination medical institutions and examination devices installed therein are associated with each others with respect to each of the plurality of examination request source medical institutions, in a first database, transmitting to the first terminal, when a list of examination devices installed in the plurality of examination request destination medical institutions selected by the examination request source medical institution is requested from the first terminal, list data obtained by retrieving the list data associated with the examination request source medical institution in the first database, generating appointment status data representing a calendar page including a plurality of appointment frames relating to appointment status of examinations employing the designated examination device in the designated examination request destination medical institution to transmit the appointment status data to the first terminal, and making an examination appointment by storing the examination appointment information received from the first terminal in a second database.

Furthermore, a server according to the present invention is a server connected to first terminals respectively installed in a plurality of examination request source medical institutions and second terminals respectively installed in a plurality of examination request destination medical institutions, which perform examinations intended for diagnosis in accordance with requests from the plurality of examination request source medical institutions via a network, and the server includes: storage control means for storing list data, in which selected examination request destination medical institutions and examination devices installed therein are associated with each others with respect to each of the plurality of examination request source medical institutions, in a first database; retrieval control means for retrieving the list data associated with one of the plurality of examination request source medical institutions in the first database when a list of examination devices installed in the examination request destination medical institutions selected by the examination request source medical institution is requested from a first terminal of the examination request source medical institution; transmission data generating means for generating appointment status data representing a calendar page including a plurality of appointment frames relating to appointment status of examinations employing the designated examination device in the designated examination request destination medical institution in the list of examination devices displayed in the first terminal; and examination appointment managing means for making an examination appointment by storing examination appointment information in a second database, the examination appointment information representing an appointment frame designated in the calendar page displayed in the first terminal based on the appointment status data.

### BRIEF DESCRIPTION OF THE DRAWINGS

FIG. 1 is a schematic diagram showing the configuration of an examination appointment system according to one embodiment of the present invention;

FIG. 2 is a block diagram showing the constitution of a client terminal installed in a clinic;

FIG. 3 shows an example of examination appointment screen for making examination appointments in the client terminals;

FIG. 4 shows an example of examination appointment screen for making examination appointments in the client terminals;

FIG. 5 is a block diagram showing the constitution of a schedule management terminal installed in a hospital;

FIG. 6 shows an example of examination schedule screen for reception of patients in the schedule management terminal;

FIG. 7 shows an example of examination schedule screen for reception of patients in the schedule management terminal;

FIG. 8 is a block diagram showing the constitution of a database server;

FIG. 9 is a flowchart showing the operation of the examination appointment system as shown in FIG. 1 in the case of storing medical data;

FIG. 10 is a flowchart showing the operation (first half) of the examination appointment system as shown in FIG. 1 in the case of making an examination appointment;

FIG. 11 is a flowchart showing the operation (second half) of the examination appointment system as shown in FIG. 1 in the case of making an examination appointment;

FIG. 12 is a flowchart showing the operation of the examination appointment system as shown in FIG. 1 in the case of updating appointment status data;

FIG. 13 is a flowchart showing the operation of the examination appointment system as shown in FIG. 1 in the case of reception of a patient scheduled for examination; and

FIG. 14 is a flowchart showing the operation of the examination appointment system as shown in FIG. 1 in the case where an examination of a patient and interpretation have been completed.

### DESCRIPTION OF THE PREFERRED EMBODIMENTS

Hereinafter, an embodiment of the present invention will be described in detail by referring to the drawings. The same reference numerals are assigned to the same component elements and the description thereof will be omitted.

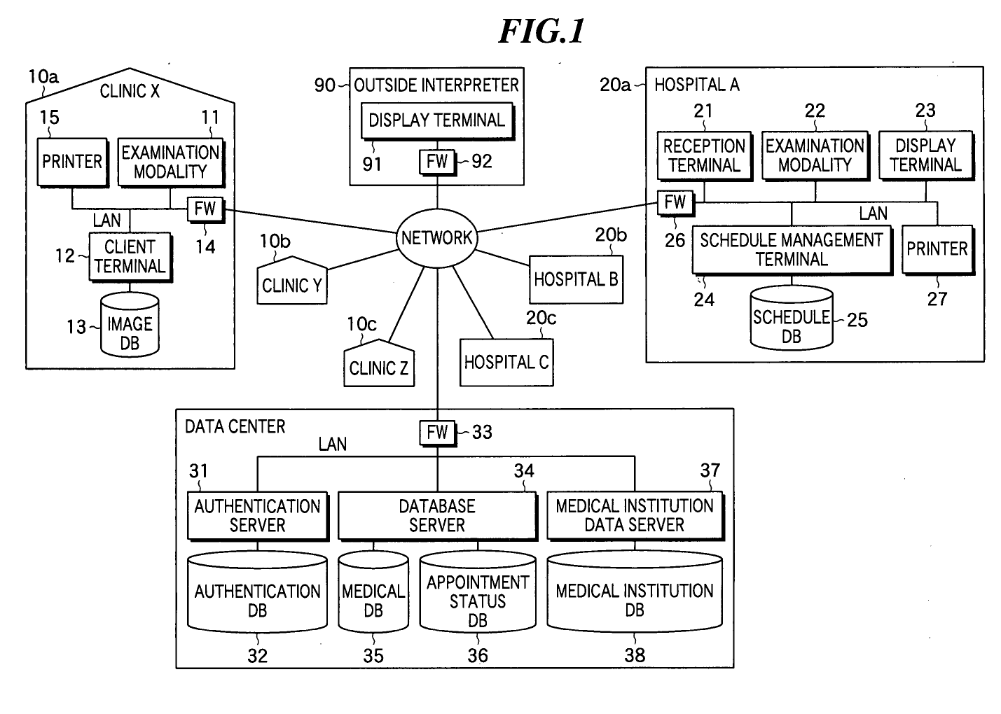

FIG. 1 is a schematic diagram showing a configuration of an examination appointment system according to one embodiment of the present invention. As shown in FIG. 1, this examination appointment system includes clinic X (10a), clinic Y (10b), clinic Z (10c), . . . as examples of small medical institutions and hospital A (20a), hospital B (20b), hospital C (20c), . . . as examples of large medical institutions, and a data center 30. The clinics 10a, 10b, 10c, . . . and hospitals 20a, 20b, 20c, . . . are connected to the data center 30 via a network such as a dedicated line, a public switched telephone network (PSTN), the Internet, or the like. Further, an outside interpreter 90 or the like may be connected to the data center 30 via the network.

In the respective clinic X (10a), clinic Y (10b), clinic Z (10c), . . . , various kinds of examination modalities 11 such as radiation imaging apparatuses or ultrasonic diagnostic apparatuses, client terminals 12 for receiving medical data such as image data representing medical images from the examination modalities 11 and transferring the data to the data center 30, recoding media such as hard disks in which image databases (DB) 13 for storing the image data etc. received from the examination modalities 11 are recorded, firewalls (FW) 14 for preventing unauthorized access, printers 15 for printing out medical images on films or the like, etc. are connected via local area networks (LANs) to each others.

The client terminal 12 controls the examination modality 11 according to patient attribute information and examination attribute information inputted by an operator or received from another terminal and operator's instructions, receives image data and image-associated information from the examination modality 11, associates the image-associated information with the patient attribute information and examination attribute information, and stores the patient attribute information and examination attribute information as well as the image data in the image database 13.

Here, the patient attribute information includes information representing name of patient, ID number, sex, age, date of birth and so on. Further, the examination attribute information includes information representing date of examination, date of consultation, imaging menu, image feature and so on. The examination menu includes a part to be examined as a target of imaging such as cephalic part, cervical part, thoracic part, thoracoabdominal part, abdominal part, lumber spine, four limbs or the like and imaging method such as front or side as imaging directions toward a patient.

In the client terminal 12, image processing can be performed on the image data, or images for diagnosis can be displayed on a display or the like based on the image data, patient attribute information, and examination attribute information. Note that, because a vast amounts of image data are daily accumulated, they are stored not for a long period in the clinic, but transferred to the data center apart from the clinic and stored there. Thereby, in the clinic, space for storing recording media, in which medical data have been recorded, and costs for securing the space can be reduced.

In the case where an examination employing an examination device that is not installed in the clinic is required, the clinic requests an examination to hospital A (20a), hospital B (20b), hospital C (20c) or the like via the data center 30. At this time, the client terminal 12 receives appointment status data representing a calendar page showing an appointment status of the examination from the data center 30 and an examination appointment screen is displayed on a display or the like. To make an examination appointment, examination appointment information is transmitted from the client terminal 12 to a database server 34. Further, after making an examination appointment, the client terminal 12 can display a progress status of the examination based on status information transmitted from the database server 34.

In each of hospital A (20a), hospital B (20b), hospital C (20c), . . . , a reception terminal 21, an expensive examination modality 22 such as CT (computed tomography) device, MRI (magnetic resonance imaging) device or ES (endoscope) device, an image display terminal 23 for receiving medical data such as image data representing medical images from the examination modality 22 to display medical image and transferring the medical data to the data center 30, a schedule management terminal 24 for managing a schedule of examinations, a recoding medium such as a hard disk in which a schedule database (DB) 25 storing schedule information of examinations is recorded, a firewall (FW) 26 for preventing unauthorized access, a printer 27 for printing out medical images on films or the like, etc. are connected via a local area network (LAN) to each others.

The reception terminal 21 is used, at a reception of a hospital or the like, for inputting patient information such as name of patient. When a patient to be examined visits a hospital, an operator confirms whether the visiting patient have made an examination appointment or not, and, in the case where the patient have made an examination appointment, makes a request to the schedule management terminal 24 to change the status regarding the examination of the patient.

Here, the status information representing statuses of examination from the examination appointment to acquisition of examination result has a two-layered structure. As a status in the principal layer, “no appointment”, “appointed”, “patient reception”, “examination completed”, “interpretation completed”, or the like is used. As a status in the accessory layer, for example, “available” and “not available” are used for “no appointment”, and “normal” and “abnormal” are used for “appointed”. “Abnormal” represents that a patient does not come to the examination, or the examination is not finished.

The image display terminal 23 performs image processing on the image data, and displays medical images for diagnosis based on the image data and image-associated information on a display or the like. The image display terminal 23 receives the patient attribute information and examination attribute information inputted by an operator or transmitted from the schedule management terminal 24, receives examination appointment information, and receives image data and image-associated information from the examination modality 22. Further, the terminal 23 associates the image-associated information with the patient attribute information and examination attribute information and further the examination appointment information, and stores those kinds of information with the image data.

When an examination is performed based on the examination appointment information received from the schedule management terminal 24, the image display terminal 23 transfers the image data obtained by the examination to the data center 30 and causes it to record the data, and makes a request to the schedule management terminal 24 to change the status regarding the examination into “examination completed” that represents that the examination has been completed.

Furthermore, when the interpretation is performed based on the examination appointment information received from the schedule management terminal 24, the image display terminal 23 transfers interpretation report data generated by the interpretation to the data center 30 and causes it to record the interpretation report data, and makes a request to the schedule management terminal 24 to change the status regarding the examination into “interpretation completed” that represents the interpretation has been completed.

The schedule management terminal 24 receives appointment status data representing the appointment status of the examination from the data center 30 and displays the examination appointment screen based on the appointment status data on a display or the like. Further, the schedule management terminal 24 transmits status change request signals to the database server 34 in accordance with requests for status changes from other terminals or requests for status changes inputted by the operator.

In the data center 30, there are provided an authentication server 31 for authenticating access from outside, a recording medium such as a hard disk in which an authentication database (DB) 32 for storing user information required for authentication is recorded, a firewall (FW) 33 for preventing unauthorized access, the database server 34, a recording medium such as a hard disk in which a medical database (DB) 35 is recorded, a recording medium such as a hard disk in which an appointment status database (DB) 36 is recorded, a medical institution data server 37 for managing information on examination request destination medical institutions, and a recording medium such as a hard disk in which an medical institution database (DB) 38 is recorded.

In the embodiment, the authentication server 31 is provided within the data center 30, however, the authentication server 31 may be provided outside of the data center 30. Further, an image display terminal 91 installed in the outside interpreter 90 is connected to the network via a fire wall (FW) 92.

The database server 34 accumulates the medical data transmitted from the client terminals 12 and image display terminals 23 in the medical database 35 and manages the data, and makes examination appointments in accordance with the requests from the client terminals 12. Furthermore, the examination appointment information stored in the appointment status database 36 of the data center 30 includes status information representing progress statuses of examinations and so on in two layers, and the database server 34 changes the status information according to the status change request signals transmitted from the schedule management terminals 24.

In the appointment status database 36, examination request source information is stored. The examination request source information includes names of examination request source clinics and clinic ID numbers for specifying the clinics as examination request source medical institutions, patient attribute information, and examination information. The examination information includes examination types, additional conditions as to whether a contrast agent is used or not or the like, appointed examination date and time, and statuses.

The medical institution data base server 37 receives medical institution data request signals including clinic ID numbers for specifying request source clinics transmitted from the client terminals 12, generates hospital list data representing lists of hospital names as customers based on information on all hospitals stored in the medical institution database 38, and transmits the hospital list data to the client terminals 12 as request source based on the clinic ID number included in the medical institution data request signal.

In the medical institution database 38, there is stored an examination request destination master table in which request destination hospital names and hospital ID numbers as to a large number of hospitals or the like that can be examination request destination hospitals, examination modality names representing examination modalities possessed by the respective hospitals, and examination menu names representing examination menus that can be performed by employing the examination modalities are associated.

In the embodiment, the database server 34 creates examination list tables in which, with respect to each clinic as a examination request source medical institution, request destination hospital names and hospital ID numbers representing plural hospitals selected by the clinic, examination modality names representing examination modalities possessed by the respective hospitals, and examination menu names representing examination menus that can be performed by employing the examination modalities are associated with each others based on the examination request destination master table stored in the medical institution database 38, and stores the examination list table in the appointment status database 36.

In the clinic as the examination request source, a doctor as an operator designates a request destination hospital to which a patient is to be introduced from among selected plural hospitals while referring to the examination list table with respect to the clinic and displayed in the client terminal 12, and considering the patient's needs. Thus, by opening up the options of request destination hospitals, patient's needs are easily reflected.

In the case where one request destination hospital of the selected plural hospitals, one examination modality installed in the hospital, and at least one examination menu name that can be performed by employing the examination modality are designated, the request destination hospital name and hospital ID number, examination modality name, and examination menu name are used as examination request destination information. This examination request destination information forms the examination appointment information together with the examination request source information.

Further, in the case where the request destination hospital or the like is designated, the database server 34 generates as a calendar page the appointment status of the designated examination menu employing the designated examination modality in the designated request destination hospital based on the examination request source information, and transmits the calendar page to the client terminal 12. The doctor as an operator can grasp available dates, times and so one at a glance of the calendar page displayed on the client terminal 12. Thereby, the doctor can immediately make an appointment at the designated request destination hospital, and waiting time of the patient can be drastically reduced.

Furthermore, in the case where the creation of examination result image, interpretation result report, etc. are completed in the request destination hospital, the doctor of the examination request source can be informed of timing, at which the information of images, reports or the like becomes able to be referred, based on the status of “no appointment”, “appointed”, “patient reception”, “examination completed”, “interpretation completed” and so on displayed on the client terminal 12. Thereby, the doctor of the examination request source can predict the time when the entire examination in the examination request destination hospital is completed and the patient revisits the clinic.

In addition, the database server 34 controls access to medical data from the client terminals 12 and the image display terminal 91 installed in the outside interpreter 90 based on the status regarding the examination, and thereby, can perform practices such as examination and interpretation in cooperation.

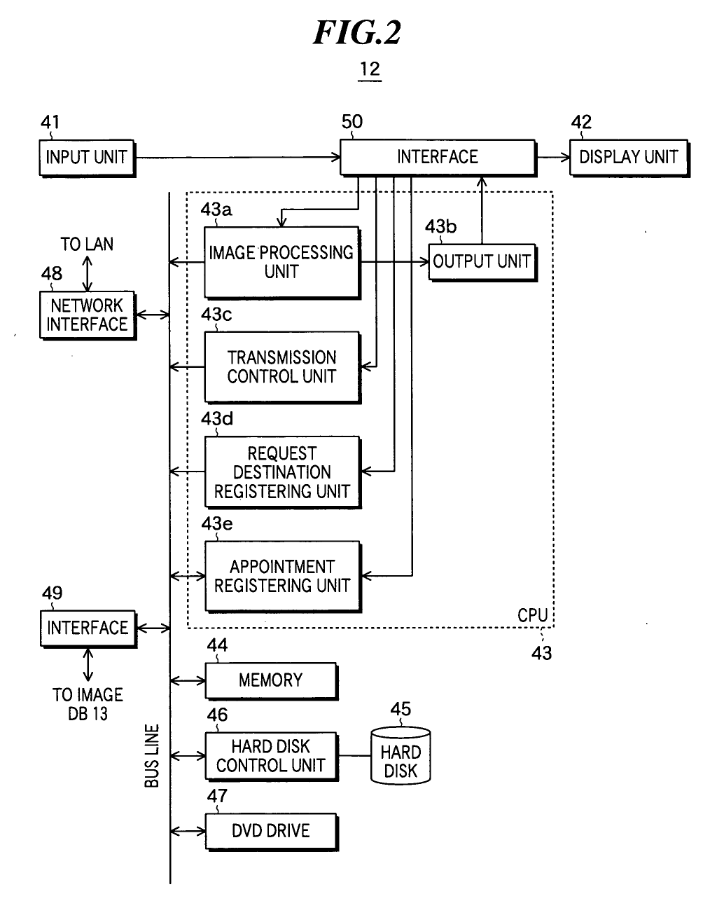

FIG. 2 is a block diagram showing the constitution of a client terminal installed in a clinic. The client terminal 12 includes an input unit 41 such as a keyboard or mouse to be used for inputting various kinds of instructions etc., a display unit 42 such as a CRT or LCD display for displaying medical images etc. represented by image data received from the examination modality 11, a central processing unit (hereinafter, referred to as CPU) 43 to which the input unit 41 and display unit 42 are connected via an interface 50, a memory 44, a hard disk 45, a hard disk control unit 46 for controlling writing and reading of data in the hard disk 45, a DVD drive 47 for performing writing and reading of data on a DVD (digital versatile disk), a network interface 48 for connection to a LAN, and an interface 49 for controlling the hard disk etc. in which the image database (DB) 13 is recorded. These units 43-49 are connected to each others via a bus line.

The memory 44 temporarily stores the received image data, patient attribute information, examination attribute information and soon. In the hard disk 45, software (program) for actuating the CPU 43 to perform operation is recorded. As the recording medium for recording the program, not only the built-in hard disk 45, but also an external hard disk, a flexible disk, an MO, an MT, a RAM, a CD-ROM, a DVD-ROM, or the like may be used.

Next, function blocks 43a to 43e formed by the CPU 43 and software (program) will be described.

The image processing unit 43a performs necessary image processing on the image data received from the examination modality 11 to generate display data for displaying images on the display unit 42. Further, the image processing unit 43a generates display data for displaying images on the display unit 42 based on the image data received from the data center 30.

The display data is supplied from the output unit 43b via the interface 50 to the display unit 42. Images are displayed on the display unit 42 based on the display data, and the images are confirmed by the operator. Further, the image data that has been subjected to the necessary image processing is stored with the patient attribute information and examination attribute information and so on in the memory 44, and furthermore, stored in the image database 13 according to the set conditions.

In order to store the medical data such as image data in the data center 30, the transmission control unit 43c starts to access the data center 30 according to the instructions by the operator using the input unit 41 or set conditions. In the data center 30, in order to prevent leaks of personal information, falsification of medical image data or the like, an authentication is requested for access to the database server 34, and access to the database server 34 is inhibited until it is allowed by the authentication.

When the transmission control unit 43c makes inquiries about access right to the authentication server 31 of the data center 30 and the access right is authenticated in the authentication server 31, the transmission control unit 43c transmits the medical data stored in storage means such as the memory 44 or hard disk 45 to the database server 34 and causes the server to store the data.

When newly registering a hospital, which is in cooperation with the clinic, as a request destination, the request destination registering unit 43d starts to access the data center 30 in accordance with the request inputted by using the input unit 41. When the access right is authenticated in the authentication server 31 as shown in FIG. 1, the request destination registering unit 43d transmits a medical institution data request signal including the clinic ID number of the request source to the medical institution data server 37 so that the medical institution data server 37 transmits hospital list data representing a list of all hospital names etc. registered in the examination request destination master table in the medical institution database 38.

The hospital list data transmitted from the medical institution data server 37 is received by the request destination registering unit 43d and sent to the image processing unit 43a. The list of all hospital names etc. is displayed on the display unit 42 based on the hospital list data.

When a hospital to be registered is newly selected, the request destination registering unit 43d transmits a registration request signal including a hospital ID number representing the selected hospital to the database server 34 according to the instruction by the operator using the input unit 41. The registration request signal includes the clinic ID number for specifying items of the examination list table registered with respect to each clinic along with the hospital ID number representing the selected hospital. Thereby, the database server 34 updates the examination list table with respect to the request source clinic.

When making an examination appointment, the appointment registering unit 43e starts to access the data center 30 in accordance with the request inputted by using the input unit 41. When the access right is authenticated in the authentication server 31, the appointment registering unit 43e transmits an examination information request signal including the clinic ID number for specifying the request source clinic to the data server 34 so that the data server 34 transmits the examination list table with respect to the request source clinic stored in the appointment status database 36.

The examination list table transmitted from the data server 34 is received by the appointment registering unit 43e and sent to the image processing unit 43a. The examination appointment screen is displayed on the display unit 42 based on the examination list table.

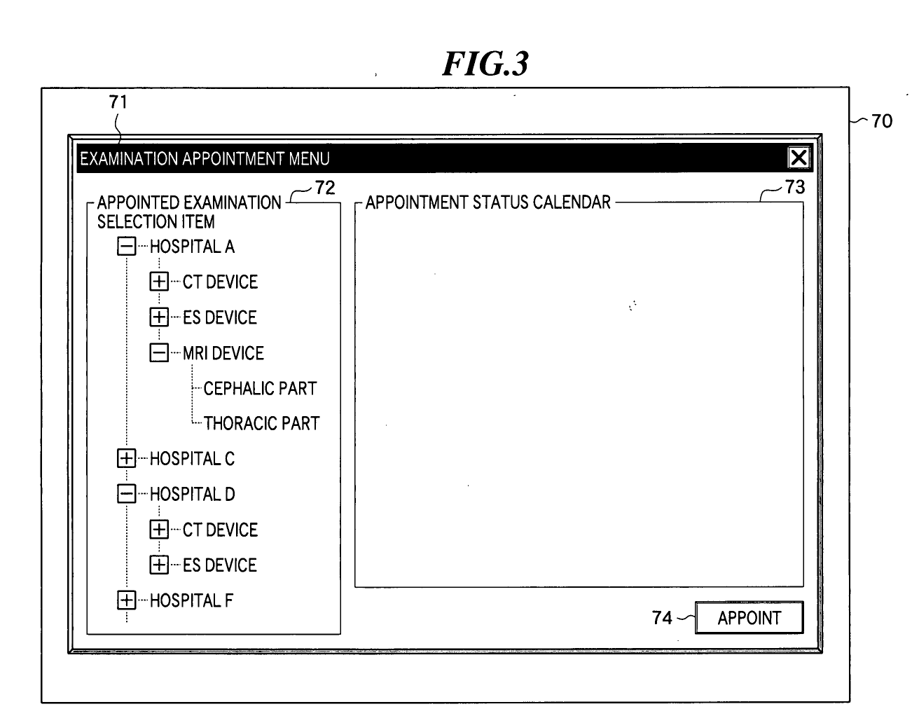

FIG. 3 shows an example of examination appointment screen for making examination appointments in the client terminals. On an examination appointment screen 70, an appointed examination selection item field 72, an appointment status calendar field 73, and an examination appointment menu 71 including an appointment button (icon) 74. In FIG. 3, information on examinations that can be designated is displayed in the appointed examination selection item field 72.

When an operator designates one of hospital names and one of examination modality names in the appointed examination selection item field 72 by clicking, and further, designates an examination menu name as an option, the appointment registering unit 43e starts to access the data center 30 in order to request a calendar page that shows an appointment status in a calendar form. When the access right is authenticated in the authentication server 31, the appointment registering unit 43e transmits an appointment status data request signal including the clinic ID number for specifying the request source clinic to the data server 34 so that the data server 34 transmits appointment status data representing the calendar page showing the appointment status of the examination employing designated examination modality in the designated hospital.

The appointment status data request signal includes the hospital ID number of the designated hospital, designated examination modality name, and further, the examination menu name designated as an option.

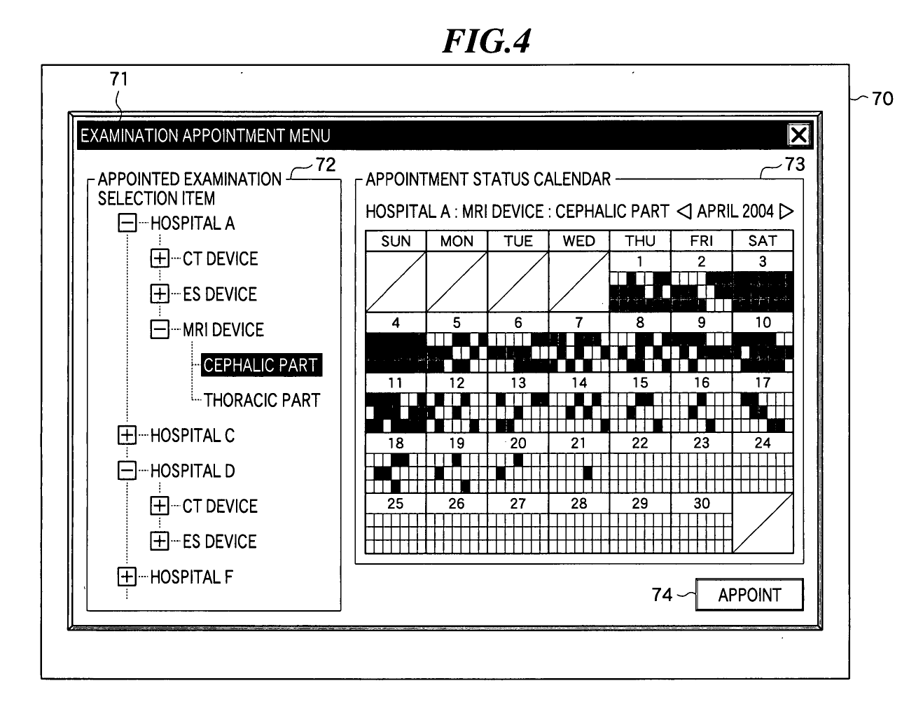

The appointment status data transmitted from the data server 34 is received by the appointment registering unit 43e and sent to the image processing unit 43a. The examination appointment screen as shown in FIG. 4 is displayed on the display unit 42 based on the appointment status data. In this examination appointment screen, the appointment status is displayed as a calendar page having a calendar form.

In the examination appointment screen as shown in FIG. 4, in order to grasp the appointment status at a glance, available appointment frames are displayed by a color representing availability (white in FIG. 4) and the unavailable appointment frames are displayed by a color representing unavailability (gray in FIG. 4). Here, the appointment frames are time segments corresponding to examination times. Normally, an examination employing a CT device or MR device takes time for 20 minutes or 40 minutes per one examination. Accordingly, 20 minutes as the minimum examination unit is set as time of one appointment frame, two continuous appointment frames are appointed for a 40-minute examination. Further, as shown in FIG. 4, the vertically arranged three rows of appointment frames represent the appointment status for one hour, and the rows are horizontally arranged in seven columns to represent the appointment status for seven hours.

Sometimes the times required for examinations differ not only depending on types of examination modalities but also depending on types of examinations to be performed even when the same examination modality is employed. For example, when a general checkup is performed by employing the CT device or MRI device, since the required number of slices is not so much larger, there is no problem if the time for one appointment frame is short. On the other hand, in the case of detailed examination even when the same CT device or MRI device is employed, since a large number of slices are required and sometimes plain imaging and contrast imaging are performed in a pair, it is necessary to set long time as an appointment frame. Thus, sometimes the minimum examination unit of time differs depending on types of examinations, and therefore, the appointment frames may be set for accommodating the differences. For example, only checkups are accepted from 9 a.m. to 10 a.m. on every Wednesday, and the minimum examination unit of time is set to 10 minutes in the period.

When the operator designates one of the appointment frames in the appointment status calendar 73 as shown in FIG. 4 by clicking or the like, and further, clicks the appointment button 74, the appointment registering unit 43e reads out patient attribute information representing the patient who wishes to request the examination from the image database 13 or the like, and transmits the examination appointment information including examination request destination information and examination request source information to the database server 34.

In the appointment status calendar 73 as shown in FIG. 4, the appointment frames, in which the request source clinics have been made appointments, are displayed in colors which are different from available and unavailable and which are based on the statuses of “appointed”, “patient reception”, “examination completed”, and “interpretation completed”. Thereby, the operator can grasp the progress statuses of the appointed examinations at a glance.

After the examination appointments are made, the operator can refer to medical images of the patient taken in the past by double clicking the appointment frames showing the status of “appointed” or “patient reception”. Further, the operator can confirm the medical images taken in the requested hospital by double clicking the appointment frames showing the status of “examination completed”. Furthermore, the operator can view the results interpreted in the requested hospital by double clicking the appointment frames showing the status of “interpretation completed”.

By the way, although the image processing unit 43a, output unit 43b, transmission control unit 43c, request destination registering unit 43d, and appointment registering unit 43e as shown in FIG. 2 are formed by a CPU and software in the embodiment, those respective units may be formed by digital circuits or analog circuits.

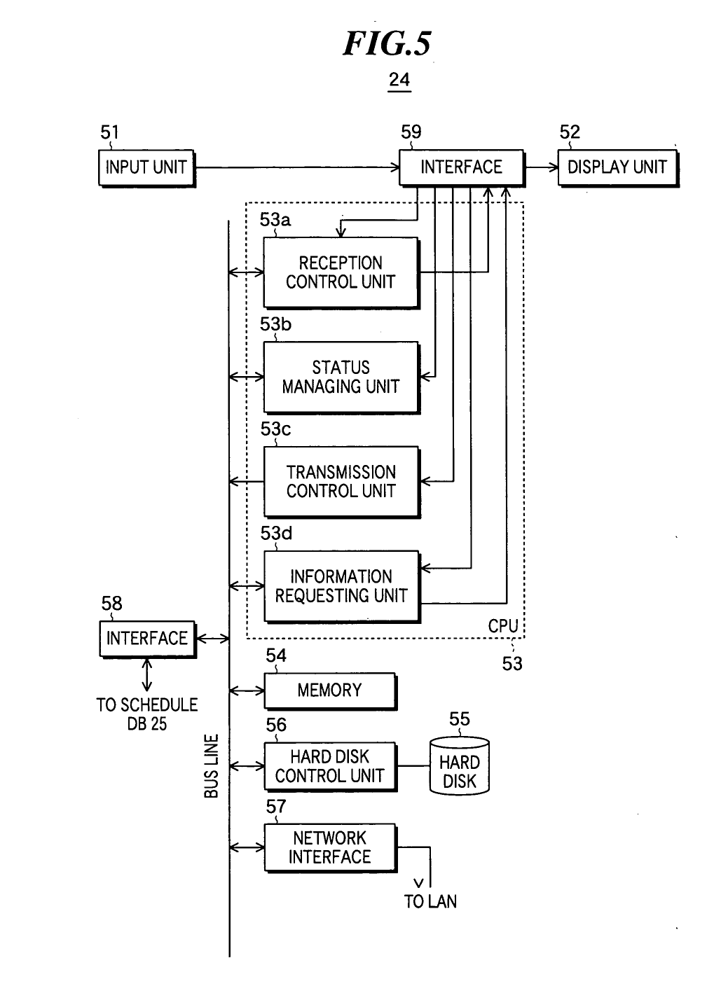

FIG. 5 is a block diagram showing the constitution of the schedule management terminal 24 installed in the hospitals 20a, 20b, . . . as shown in FIG. 1. The schedule management terminal 24 includes an input unit 51 such as a keyboard or mouse to be used for inputting various kinds of instructions etc., a display unit 52 such as a CRT or LCD display for displaying images for operation etc., a central processing unit (hereinafter, referred to as CPU) 53 to which the input unit 51 and display unit 52 are connected via an interface 59, a memory 54, a hard disk 55, a hard disk control unit 56 for controlling writing and reading of data in the hard disk 55, a network interface 57 for connection to a LAN, and an interface 58 for controlling the hard disk etc. in which a schedule database (DB) 25 is recorded. These parts 53 to 58 are connected to each others via a bus line.

The memory 54 temporarily stores appointment status data representing a calendar page and the examination attribute information transmitted from the database server and other data. In the hard disk 55, software (program) for actuating the CPU 53 to perform operation is recorded. As the recording medium for recording the program, not only the built-in hard disk 55, but also an external hard disk, a flexible disk, an MO, an MT, a RAM, a CD-ROM, a DVD-ROM, or the like can be used.

Next, function blocks 53a to 53d formed by the CPU 53 and software (program) will be explained.

The reception control unit 53a receives the appointment status data and examination appointment information transmitted from the database server 34 as shown in FIG. 1, and further, receives requests for status change transmitted from the reception terminal 21 or the image display terminal 23.

The status managing unit 53b stores the appointment status data received by the reception control unit 53a in the schedule database 25 and manage the appointment status data. Further, the status managing unit 53b generates status change request signals including statuses to be changed such as “appointed”, “patient reception”, “examination completed”, “interpretation completed”, etc. and the examination appointment information in order to change the statuses stored in the appointment status database 36 (FIG. 1) in accordance with the requests for status change transmitted from the reception terminal 21 or the image display terminal 23 or requests for status change inputted by the operator.

When the status managing unit 53b generates a status change request signal, the transmission control unit 53c makes inquiries about access right to the authentication server 31 of the data center 30. When the access right is authenticated in the authentication server 31, the transmission control unit 53c transmits the status change request signal to the database server 34.

The information requesting unit 53d regularly transmits appointment status data request signals including hospital ID numbers for specifying the request source hospital to the data server 34 so that the data server 34 transmits appointment status data stored in the schedule database server 25 and examination appointment information on the request source hospitals.

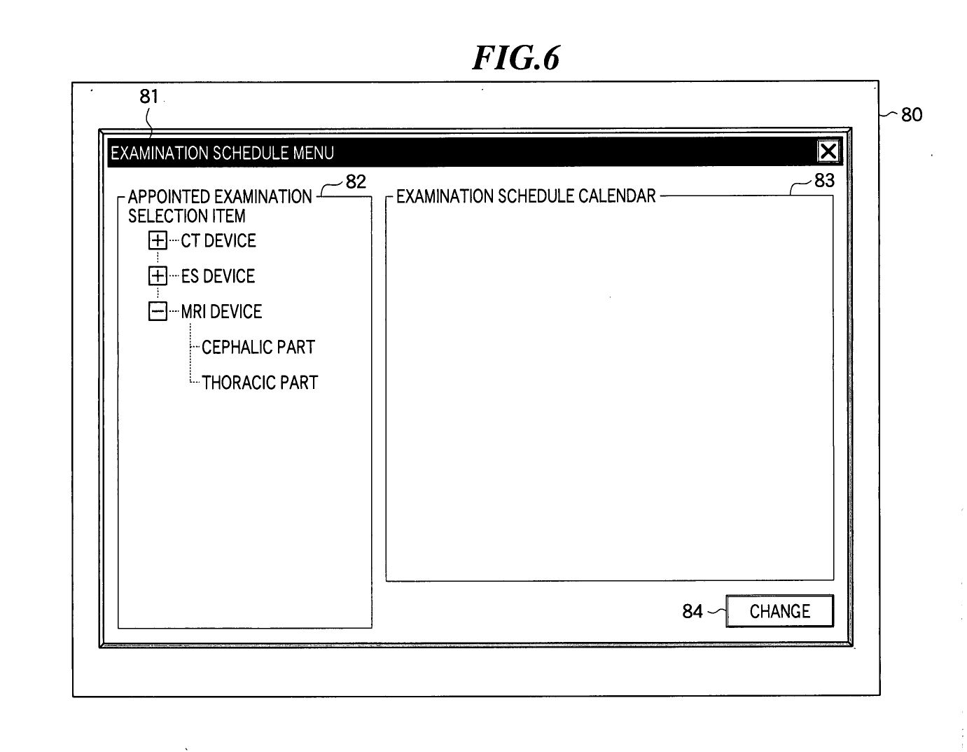

FIG. 6 shows an example of examination schedule screen for reception of patients in schedule management terminals. On an examination schedule screen 80, an examination schedule selection item field 82, an examination schedule calendar field 83, and an examination schedule menu 81 including a change button (icon) 84 are displayed. In FIG. 6, information on examination schedules that can be designated is displayed in the examination schedule selection item field 82.

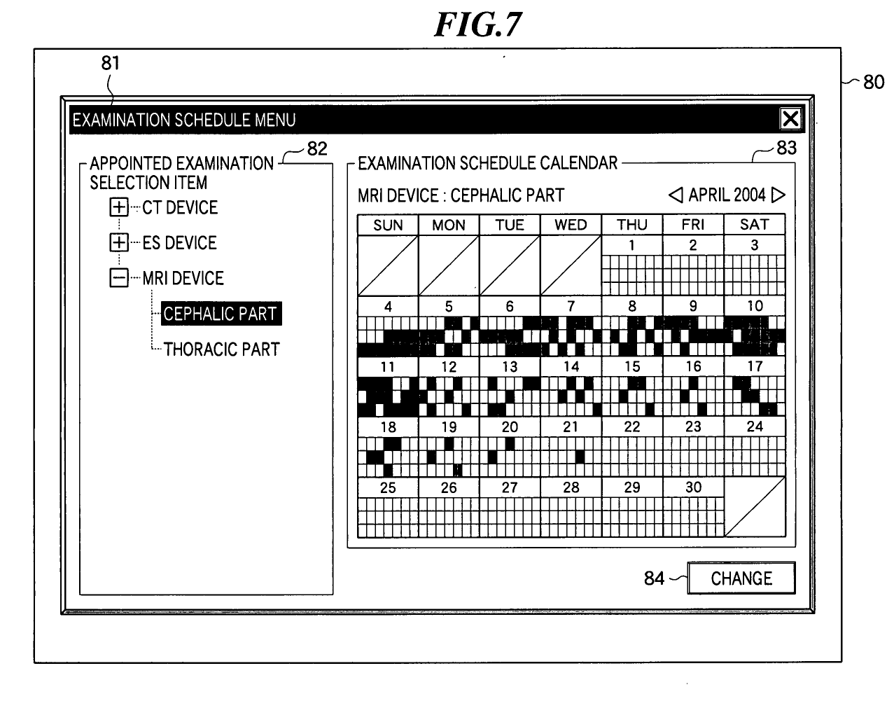

When an operator designates one of examination modality names in the examination schedule selection item field 82 by clicking, an examination schedule screen as shown in FIG. 7 is displayed based on the appointment status data representing the calendar page showing the examination appointment status as to the examination employing the designated examination modality. In this examination schedule screen, the appointment status is displayed as a calendar page having a calendar form.

In the examination appointment screen as shown in FIG. 7, in order to grasp the progress statuses of the appointed examinations at a glance, appointment frames of “no appointment” are displayed by a color representing no appointment (white in FIG. 7) and appointment frames other than “no appointment” are displayed by colors different from that for “no appointment” based on statuses of “appointed”, “patient reception”, “examination completed” and “interpretation completed”.

The status is changed according to requests for status change transmitted from the reception terminal 21 or the image display terminal 23. Alternatively, the status may be changed by the operation of the operator. For example, when the operator designates one of the appointment frames by clicking or the like and clicks the change button 84, the status moves a step forward.

The status managing unit 53b generates a status change request signal including a status to be changed such as “appointed”, “patient reception”, “examination completed”, “interpretation completed” etc. and the examination appointment information in accordance with the request for status change. The transmission control unit 53c transmits the generated status change request signal to the database server 34.

Further, the operator can refer to medical images of the patient taken in the past by double clicking the appointment frames showing the status of “appointed” or “patient reception”. Further, the operator can confirm the medical images taken in the requested hospital by double clicking the appointment frames showing the status of “examination completed”. Furthermore, the operator can view the results interpreted in the requested hospital by double clicking the appointment frames showing the status of “interpretation completed”.

By the way, although the reception processing unit 53a, status managing unit 53b, transmission control unit 53c, and information requesting unit 53d as shown in FIG. 5 are formed by a CPU and software in the embodiment, those respective units may be formed by digital circuits or analog circuits.

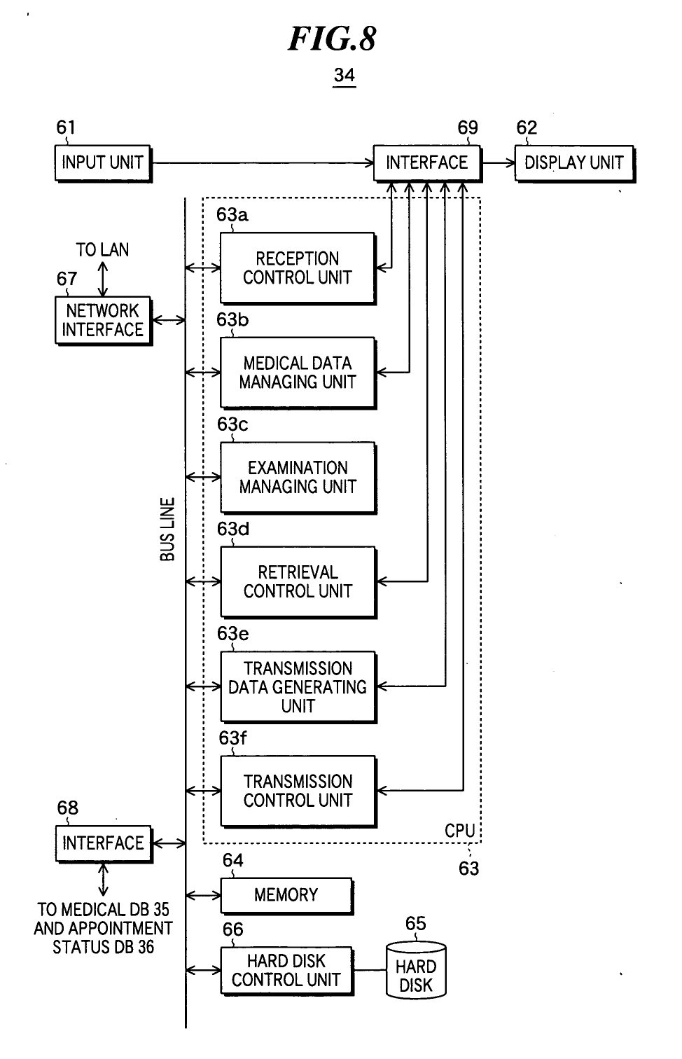

FIG. 8 is a block diagram showing the constitution of the database server 34 as shown in FIG. 1. The database server 34 includes an input unit 61 to be used for inputting various kinds of instructions etc., a display unit 62 for display for operation, a central processing unit (hereinafter, referred to as CPU) 63 to which the input unit 61 and the display unit 62 are connected via an interface 69, a memory 64, a hard disk 65, a hard disk control unit 66 for controlling the hard disk 65, a network interface 67 for connection to a LAN, and an interface 68 for controlling hard disks etc. in which the medical database (DB) 35 and appointment status database (DB) 36 are recorded. These parts 63 to 68 are connected to each others via a bus line.

The memory 64 temporarily stores the medical data, medical institution data request signals, registration request signals, examination information request signals, appointment status data request signals, and examination appointment information received from the client terminals 12 (FIG. 1) and the medical data received from the image display terminals 23, and the status change request signals and appointment status data request signals received from the schedule management terminals 24.

In the hard disk 65, software (program) for actuating the CPU 63 to perform operation is recorded. As the recording medium for recording the program, not only the built-in hard disk 65, but also an external hard disk, a flexible disk, an MO, an MT, a RAM, a CD-ROM, a DVD-ROM, or the like can be used.

Next, function blocks 63a to 63f formed by the CPU 63 and software (program) will be described.

The reception control unit 63a receives the medical data transmitted from the client terminal 12 or the image display terminal 23, the examination appointment information etc. transmitted from the client terminal 12, and the status change request signals etc. transmitted from the schedule management terminal 24.

The medical data managing unit 63b stores the medical data received by the reception control unit 63a in the medical database 35 and manages the data.

The examination managing unit 63c manages examination appointments and progress statuses based on the examination appointment information and the status change request signals received by the reception control unit 63a, sets and changes the status information stored in the appointment status database 36 as shown in FIG. 1. Further, the examination managing unit 63c manages access to medical data from the medical institutions and outside interpreters based on the status information. For example, the examination managing unit 63c provides the examination request source clinic with access right to the medical data when the status becomes “examination completed”.

The retrieval control unit 63d retrieves, based on the clinic ID number included in the examination information request signal received by the reception control unit 63a, the examination list table corresponding to the clinic ID number stored in the appointment status database 36. Further, the retrieval control unit 63d retrieves, based on the hospital ID numbers, examination modality names, examination menu names included in the appointment status data request signals from the clinics or hospital ID numbers included in the appointment status data request signals from hospitals received by the reception control unit 63a, the examination appointment information on corresponding examinations stored in the appointment status database 36.

When a registration request signal for requesting a new registration of the selected hospital is received, the transmission data generating unit 63e generates or updates, based on the hospital ID number and clinic ID number included in the registration request signal, the examination list table with respect to the clinic represented by the clinic ID number included in the registration request signal.

Further, when an appointment status data request signal transmitted from a clinic is received, the transmission data generating unit 63e generates, based on the status information included in the examination appointment information retrieved by the retrieval control unit 63d, appointment status data for clinics for displaying the calendar page showing the appointment status of the designated examination modality in a predetermined period.

Furthermore, when an appointment status data request signal transmitted from a hospital is received, the transmission data generating unit 63e generates, based on the status information included in the examination appointment information retrieved by the retrieval control unit 63d, appointment status data for displaying the calendar page showing the appointment status in a predetermined period with respect to each of examination modalities installed in the hospital.

When an examination information request signal is received, the transmission control unit 63f transmits, based on the clinic ID number for specifying the request source clinic included in the examination information request signal, the examination list table to the client terminal 12 of the request source.

Further, when examination appointment information transmitted from a clinic is received, the transmission control unit 63f transmits, based on the clinic ID number for specifying the request source clinic included in the examination appointment information, the appointment status data for clinics to the client terminal 12 of the request source.

Furthermore, when an appointment status data request signal transmitted from a clinic is received, the transmission control unit 63f transmits, based on the clinic ID number for specifying the request source clinic included in the appointment status data request signal, the appointment status data for clinics to the client terminal 12 of the request source.

In addition, when an appointment status data request signal transmitted from a hospital is received, the transmission control unit 63f transmits, based on the hospital ID number for specifying the request source hospital included in the appointment status data request signal, the appointment status data for hospitals to the image display terminal 23 of the request source.

By the way, although the reception control unit 63a, medical data managing unit 63b, examination managing unit 63c, retrieval control unit 63d, transmission data generating unit 63e, and transmission control unit 63f are formed by a CPU and software in the embodiment, those respective units may be formed by digital circuits or analog circuits.

Next, the operation of the examination appointment system according to the embodiment at the clinic side will be described by referring to FIGS. 1-4 and 8-11.

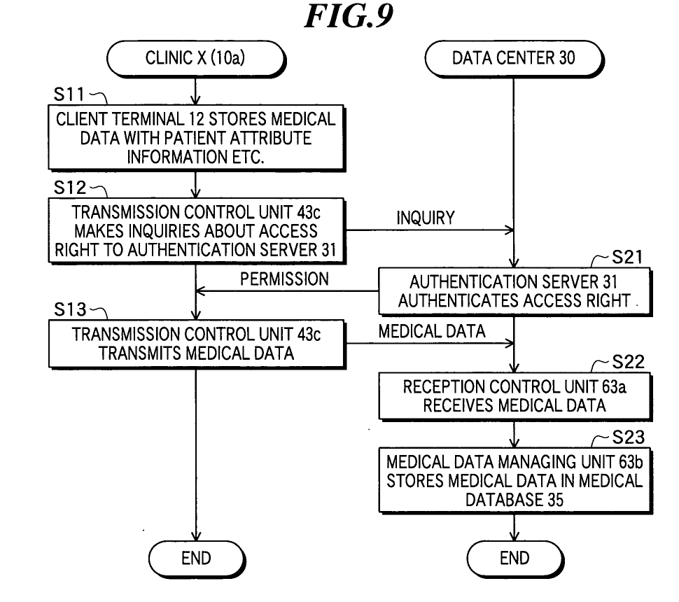

FIG. 9 is a flowchart showing the operation of the examination appointment system according to the embodiment in the case of storing medical data.

First, at step S11, the client terminal 12 of clinic X (10a) receives medical data representing an examination result from the examination modality 11 and stores the data with patient attribute information and examination attribute information in storage means such as the memory 44.

Then, at step S12, the transmission control unit 43c makes inquiries about access right to the authentication server 31 of the data center 30. When the authentication server 31 authenticates the access right at step S21, the transmission control unit 43c transmits the stored medical data such as image data from the client terminal 12 to the database server 34 of the data center 30.

At step S22, the reception control unit 63a of the database server 34 receives the medical data. At step S23, the medical data managing unit 63b stores the medical data received by the reception control unit 63a in the medical database 35. Thereby, the medical data is stored in the data center 30.

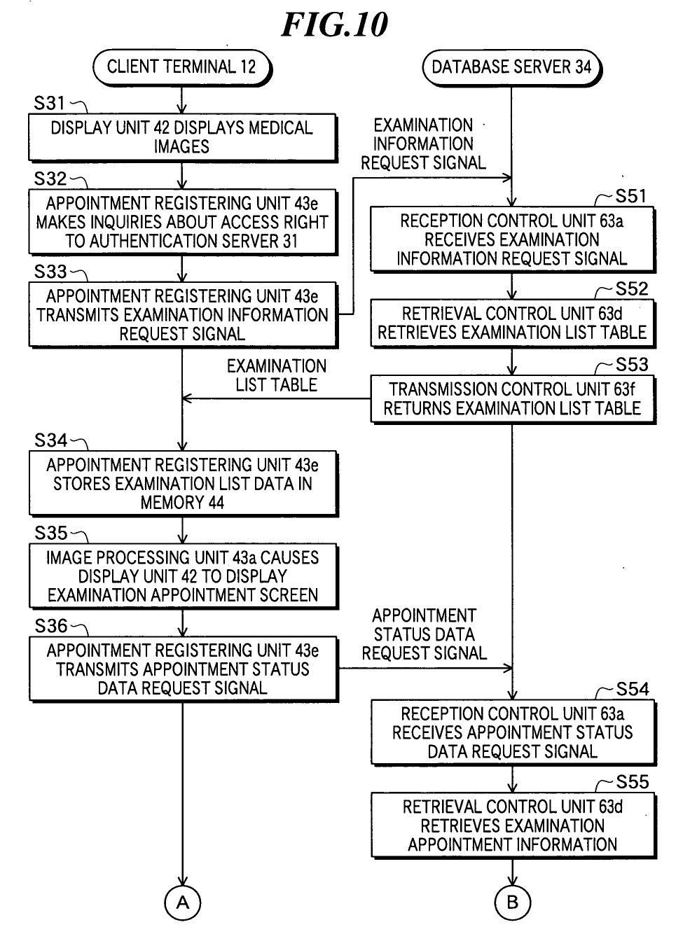

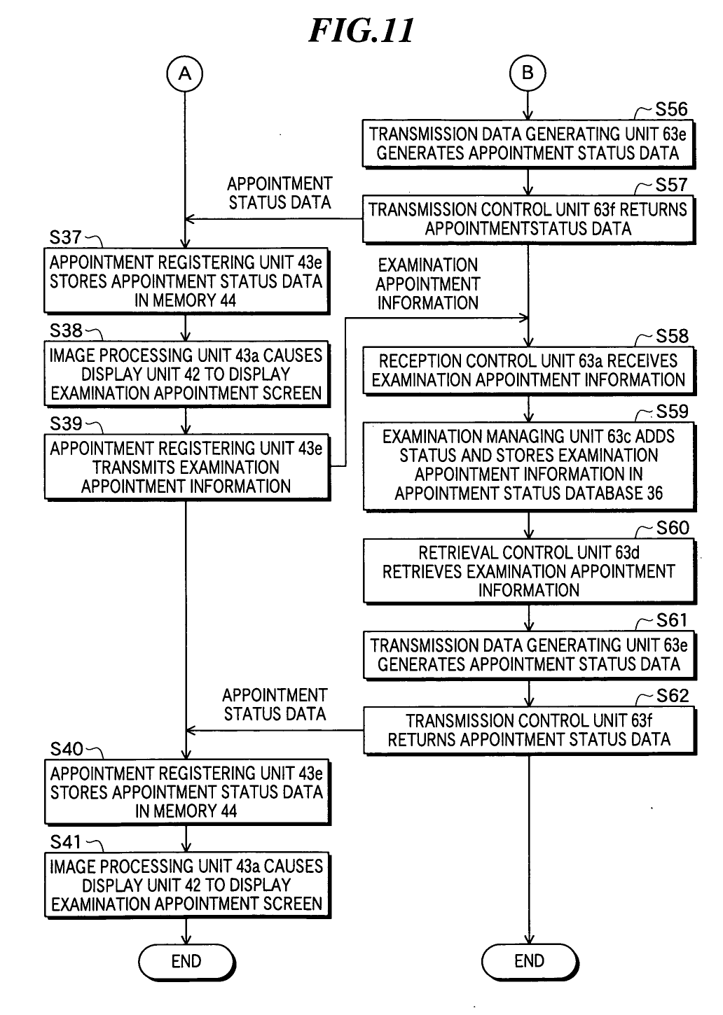

FIGS. 10 and 11 are flowcharts showing the operation of the examination appointment system according to the embodiment in the case of making an examination appointment.

At step S31, the display unit 42 of the client terminal 12 displays medical images based on image data that has been subjected to image processing. The medical images displayed on the display unit 42 are interpreted by a doctor as an operator.

When interpreting the medical images displayed on the display unit 42 and judging that a request for examination should be made, the doctor as an operator inputs an instruction of a request for information on examination that can be designated by using the input unit 41. At step S32, the appointment registering unit 43e makes inquiries about access right to the authentication server 31 of the data center 30 in accordance with the instruction of a request for information on examination that can be designated.

When the access right is authenticated by the authentication server 31, the appointment registering unit 43e transmits an examination information request signal from the client terminal 12 to the data server 34 of the data center 30 so that the data center 30 may transmit the examination list table at step S33. The examination information request signal includes a clinic name representing, for example, “clinic X” as a request source clinic requesting information on examination that can be designated.

At step S51, the reception control unit 63a of the data server 34 receives an examination information request signal. At step S52, the retrieval control unit 63d retrieves, based on the clinic ID number representing “clinic X” included in the examination information request signal received by the reception control unit 63a, the examination list table registered for “clinic X” from the appointment status database 36. The examination list table registered for “clinic X” is a table in which hospital names and hospital ID numbers of selected plural hospitals in cooperation with “clinic X”, examination modality names representing examination modalities of the respective hospitals, examination menu names that can be performed by employing the respective examination modalities are associated.

Then, at step S53, the transmission control unit 63f returns, based on the clinic ID number representing “clinic X” included in the examination information request signal, the retrieved examination list table to the transmission source client terminal 12 installed in clinic X (10a).

At step S34, the appointment registering unit 43e stores the received examination list table in the memory 44. At step S35, the image processing unit 43a causes the display unit 42 to display an examination appointment screen including a list of the hospital names of the selected plural hospitals, examination modality names installed in the respective hospitals, and examination menu names that can be performed by employing the respective examination modalities based on the examination list table stored in the memory 44.

For example, when the operator selects an examination of “cephalic part” employing “MRI device” installed in “hospital A” in the appointed examination selection item field 72 (FIG. 3) being displayed on the display unit 42 by using the input unit 41, the appointment registering unit 43e transmits an appointment status data request signal from the client terminal 12 to the data server 34 of the data center 30 at step S36 so that the data server 34 transmits appointment status data. The appointment status data request signal includes a hospital ID number representing “hospital A”, an examination modality name representing “MRI device”, and an examination menu name representing “cephalic part” together with the clinic ID number representing “clinic X”.

At step S54, the reception control unit 63a of the database server 34 receives the appointment status data request signal. At step S55, the retrieval control unit 63d retrieves, based on the hospital ID number representing “hospital A”, the examination modality name representing “MRI device” and the examination menu name representing “cephalic part” included in the appointment status data request signal, corresponding examination appointment information in the appointment status database 36.

At step S56 in FIG. 11, the transmission data generating unit 63e generates, based on the examination appointment information retrieved by the retrieval control unit 63d, appointment status data showing the appointment status of the examination of “cephalic part” to be performed by employing “MRI device” installed in “hospital A” as a calendar page.

Then, at step S57, the transmission control unit 63f returns, based on the clinic ID number representing “clinic X” included in the appointment status data request signal received by the reception control unit 63a, the retrieved appointment status data to the request source client terminal 12 installed in clinic X (10a).

At step S37, the appointment registering unit 43e stores the received appointment status data in the memory 44. At step S38, the image processing unit 43a causes the display unit 42 to display an examination appointment screen including the calendar page showing the appointment status of the examination of “cephalic part” to be performed by employing “MRI device” installed in “hospital A” as shown in FIG. 4 based on the appointment status data stored in the memory 44.

When the operator selects one or plural appointment frames in the appointment status calendar field 73 displayed in the screen of the display unit 42 by using the input device 41 and clicks the appointment button 74, the appointment registering unit 43e transmits the examination appointment information to the data server 34 of the data center 30 at step S39.

At step S58, the reception control unit 63a of the database server 34 receives the examination appointment information. At step S59, the examination managing unit 63c adds the status representing appointed to the examination information within the examination appointment information received by the reception control unit 63a, and stores the examination appointment information added with the status in the appointment status database 36. Thereby, the examination appointment is completed.

When storing the examination appointment information, the examination managing unit 63c acquires information as to storage location in the medical database 35 of the image data representing images taken in the past with respect to the patient specified by the patient attribute information included in the examination appointment information, associates the information as to storage location, as a URL (uniform resource locator), with the patient attribute information. Thereby, the doctor, who is permitted to refer, in the examination request source medical institution can refer to the images taken in the past based on the URL.

Then, at step S60, the retrieval control unit 63d retrieves, based on the hospital ID number representing “hospital A”, the examination modality name representing “MRI device” and the examination menu name representing “cephalic part” included in the appointment status data request signal, a corresponding status in the appointment status database 36.

At step S61, the transmission data generating unit 63e generates, based on the status retrieved by the retrieval control unit 63d, appointment status data representing the calendar page showing the appointment status of the examination of “cephalic part” to be performed by employing “MRI device” installed in “hospital A”.

At step S62, the transmission control unit 63f returns, based on the clinic ID number representing “clinic X” included in the appointment status data request signal received by the reception control unit 63a, the retrieved appointment status data to the request source client terminal 12 installed in clinic X (10a).

At step S40, the appointment registering unit 43e stores the received appointment status data in the memory 44. At step S41, the image processing unit 43a causes the display unit 42 to display an examination appointment screen showing the appointment status of the examination of “cephalic part” to be performed by employing “MRI device” installed in “hospital A” as a calendar page based on the appointment status data stored in the memory 44. The doctor as an operator can confirm that the examination appointment has been completed.

Next, the operation of the examination appointment system according to the embodiment in the case of updating the appointment status data will be described by referring to FIGS. 1, 5-8, and 12-14.

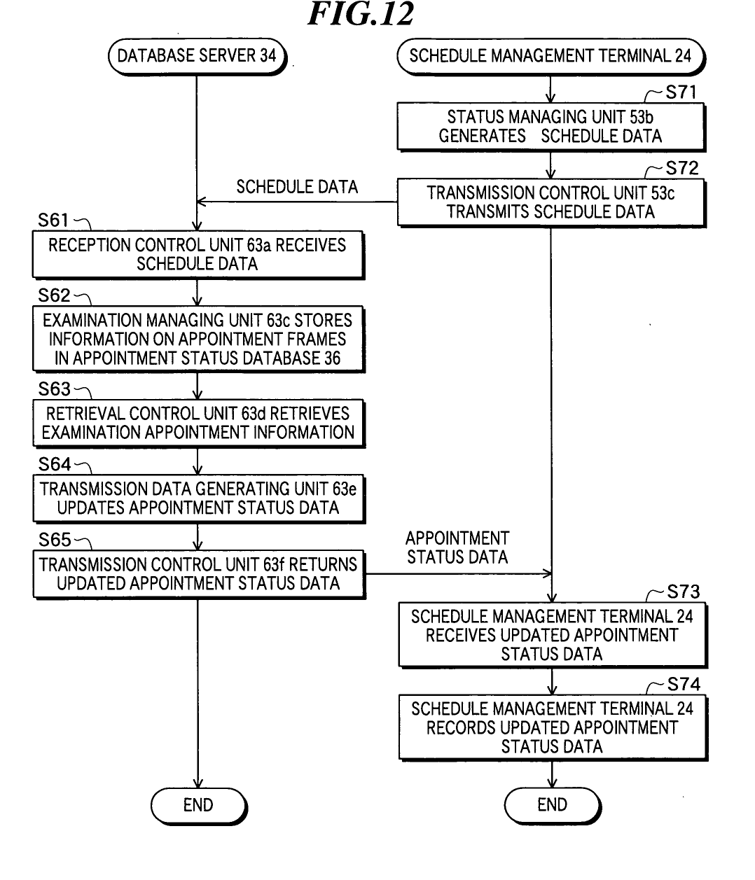

FIG. 12 is a flowchart showing the operation of the examination appointment system according to the embodiment in the case of updating the appointment status data.

First, at step S71, the status managing unit 53b of the schedule management terminal 24 generates schedule data representing whether appointments can be made or not from outside clinics with respect to plural appointment frames (appointment statuses) and/or progress statuses of examinations (examination statuses) based on the schedule information of the examinations stored in the schedule database 25. Then, at step S72, the transmission control unit 53c transmits the schedule data to the database server 34.

At step S61, the reception control unit 63a of the database server 34 receives schedule data from all hospitals within the examination appointment system. At step S62, the examination managing unit 63c stores information on plural appointment frames in the appointment status database 36 based on the received schedule data.

At step S63, the retrieval control unit 63d retrieves examination appointment information on plural examinations with respect to all hospital ID numbers, all examination modalities and all examination menu names and with respect to a predetermined period in the appointment status database 36 and reads out the statuses.

At step S64, the transmission data generating unit 63e updates appointment status data representing the appointment statuses or examination statuses in the respective appointment frames as a calendar page with respect to the appointment frames, in which the appointment statuses or examination statuses have been changed, based on the information on the plural appointment frames stored in the appointment status database 36 and the examination appointment information with respect to the plural examinations read by the retrieval control unit 63d. At step S65, the transmission control unit 63f returns the appointment status data updated at step S64 to relevant hospitals.

At step S73, the schedule management terminal 24 receives the updated appointment status data. Then, at step S74, the schedule management terminal 24 stores the updated appointment status data.

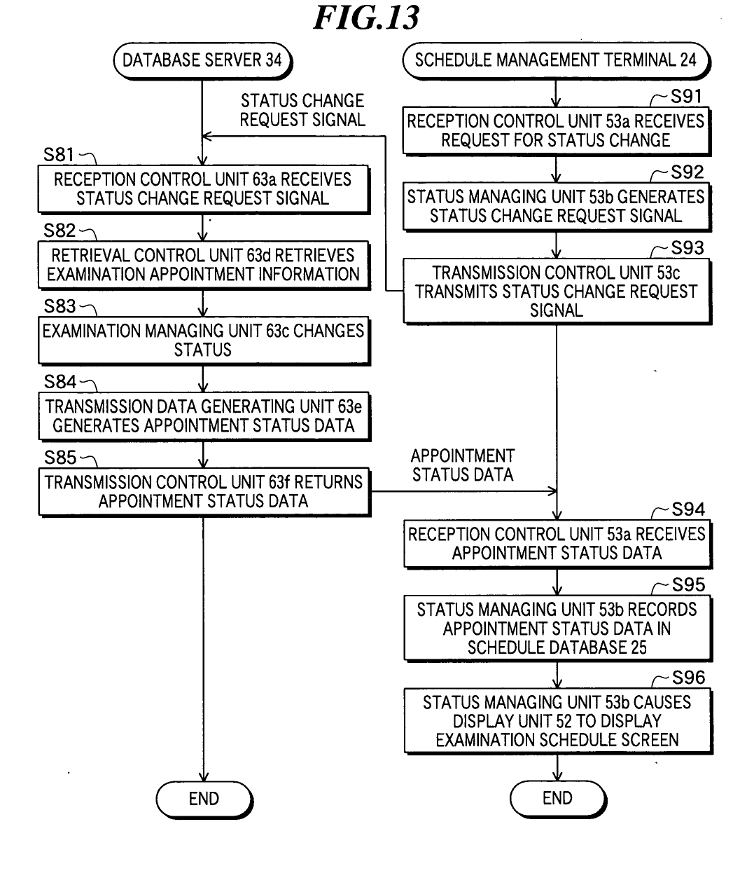

FIG. 13 is a flowchart showing the operation of the examination appointment system according to the embodiment in the case of reception of a patient scheduled for examination.

First, an operator of the reception terminal 21 confirms that the examination appointment of the visiting patient has been made at the reception. If the examination appointment has been made, the operator requests status change by using the input unit or the like of the reception terminal 21. Thereby, when the request for status change is transmitted from the reception terminal 21 to the schedule management terminal 24, the reception control unit 53a of the schedule management terminal 24 receives the request for status change at step S91.

Then, at step S92, the status managing unit 53b generates a status change request signal in order to change the status stored in the appointment status database 36 in accordance with the received request for status change. At step S93, the transmission control unit 53c transmits the status change request signal to the database server 34.

At step S81, the reception control unit 63a of the database server 34 receives the status change request signal. Then, at step S82, the retrieval control unit 63d retrieves, based on the hospital ID number, the examination modality name, and the examination menu name included in the status change request signal, examination appointment information corresponding to the same hospital ID number, the same examination modality name, and the same examination menu name in the appointment status database 36.

At step S83, the examination managing unit 63c changes the status “appointed” included in the retrieved examination appointment information into the status “patient reception” included in the status change request signal. Thereby, the examination reception has been completed.

At step S84, the transmission data generating unit 63e generates, based on the examination appointment information in which the status has been changed, appointment status data representing the appointment status of examinations as a calendar page. Then, at step S85, the transmission control unit 63f returns the appointment status data to the schedule management terminal 24 in the examination request source medical institution based on the hospital ID number included in the status change request signal.

At step S94, the reception control unit 53a of the schedule management terminal 24 receives the appointment status data. At step S95, the status managing unit 53b stores the received appointment status data in the schedule database 25. Further, at step S96, the status managing unit 53b causes the display unit 52 to display the examination schedule screen in which the status has been changed based on the appointment status data. Thereby, the operator can confirm that the status change has been completed.

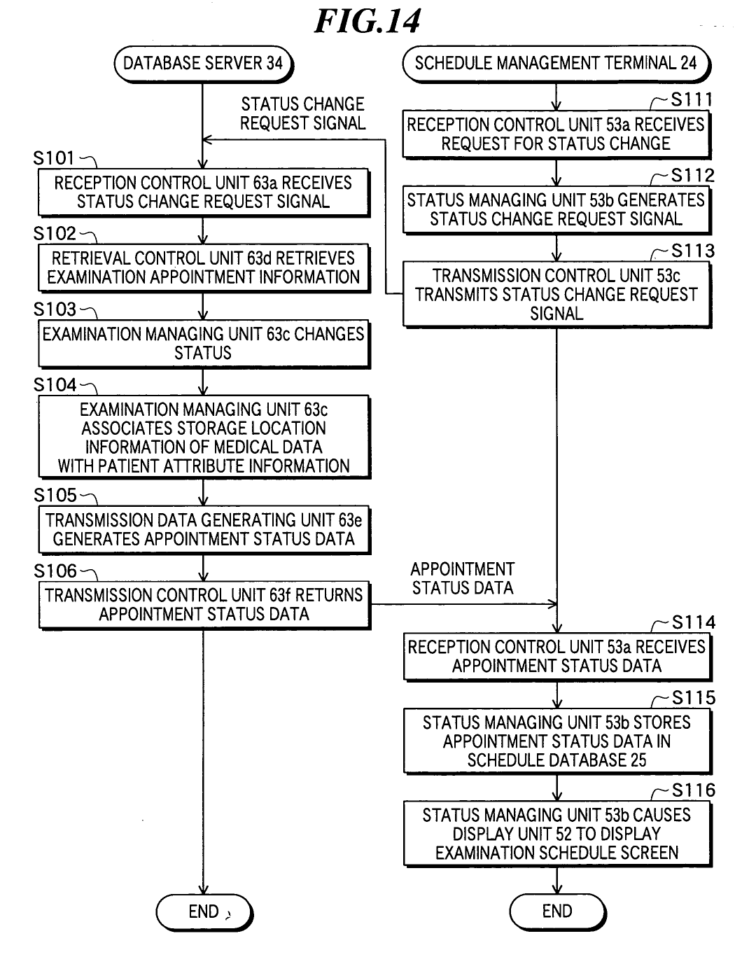

FIG. 14 is a flowchart showing the operation of the examination appointment system according to the embodiment in the case where an examination of a patient and interpretation have been completed.

When an examination and an interpretation have been completed in a hospital, medical data such as image data and interpretation report data is transmitted from the image display terminal 23 to the database server 34, and a request for status change is transmitted from the image display terminal 23 to the schedule management terminal 24. These medical data are stored in the database in the database server 34. Further, at step S111, the reception control unit 53a of the schedule management terminal 24 receives the request for status change.

Then, at step S112, the status managing unit 53b generates a status change request signal in order to change the status stored in the appointment status database 36 in accordance with the received request for status change. The status change request signal includes examination appointment information including the status to be changed, and the status “examination completed” in the case where the examination has been completed and the status “interpretation completed” in the case where the interpretation has been completed. Furthermore, at step S113, the transmission control unit 53c transmits the generated status change request signal to the database server 34.

At step S101, the reception control unit 63a of the database server 34 receives the status change request signal. Then, at step S102, the retrieval control unit 63d retrieves, based on the hospital ID number, the examination modality name and the examination menu name included in the received status change request signal, examination appointment information corresponding to the same hospital ID number, the same examination modality name and the same examination menu name in the appointment status database 36.

At step S103, when the examination has been completed, the examination managing unit 63c changes the status “patient reception” included in the retrieved examination appointment information into the status “examination completed” included in the received status change request signal. Alternatively, when the interpretation has been completed, the examination managing unit 63c changes the status “examination completed” included in the retrieved examination appointment information into the status “interpretation completed”.

Then, at step S104, the examination managing unit 63c associates the information as to storage location of medical data such as image data or interpretation report data transmitted from the image display terminal 23 when the examination or interpretation is completed, as a URL, with the patient attribute information included in the examination appointment information. Thus, by associating the information as to storage location of medical data with the patient attribute information when the status is changed, for example, a doctor who requests the examination or outside interpreter can access image data obtained from the examination results by simple operation of double clicking of appointment frames or the like.

Here, in the case of the status “examination completed”, the interpretation doctor of the examination request destination hospital, who is permitted to refer, can refer to images taken in the examination request source hospital. By the way, in the case where no request for interpretation practice is attached to the examination appointment information, the doctor of the examination request source clinic, who has made the examination appointment, may be also permitted to refer to the images taken in the examination request destination hospital. On the other hand, in the case of the status “interpretation completed”, the clinician of the examination request destination hospital, who is permitted to refer, and the doctor of the examination request source clinic, who has made the examination appointment, can refer interpretation report.

The medical data transmitted from the image display terminal 23 may be stored in the appointment status database 36, or may be recorded in a recording medium installed in the examination request source clinic, or may be recorded in a recording medium in another location connected via a network. In the case where the medical data is recorded in a recording medium installed in the examination request source clinic, redundant recording of medical data can be prevented by storing the storage location of the medical data in the appointment status database 36, and thereby, resource consumption at the data center can be suppressed.

At step S105, the transmission data generating unit 63e generates, based on the status included in the examination appointment information retrieved by the retrieval control unit 63d, appointment status data showing the appointment status of examination as a calendar page. Further, at step S106, the transmission control unit 63f returns the appointment status data to the schedule management terminal 24 as a request source installed in hospital A (20a) based on the hospital ID number included in the received status change request signal.

At step S114, the reception control unit 53a of the schedule management terminal 24 receives the appointment status data. Further, at step S115, the status managing unit 53b stores the appointment status data received by the reception control unit 53a in the schedule database 25.

At step S116, the status managing unit 53b causes the display unit 52 to display the examination schedule screen in which the status has been changed based on the appointment status data. Thereby, the operator can confirm that the status change has been completed.

Although the image data, interpretation report data, etc. are used as medical data in the embodiment, the medical data may include biochemical examination results, vital sign data, etc. Further, in the embodiment, when the status is changed, the information as to storage location of the related medical data is associated with the patient attribute information, and when the medical data is required, the medical data can be read out based on the information as to storage location. However, when the medical data is required, the medical data may be retrieved based on the patient attribute information and read out without performing association when the status is changed.

As described above, according to the present invention, list data, in which selected examination request destination medical institutions (for example, hospitals) and examination devices installed in the respective hospitals are associated, is stored with respect to each of examination request source medical institutions (for example, clinics) in the database, the list of examination devices installed in the selected hospitals is displayed in accordance with a request from one of the clinics, and a calendar page including plural appointment frames is displayed based on the hospital and the examination device designated in the displayed list. Therefore, examination appointments can be made from clinics to hospitals by easy operation and practices such as examination and interpretation can be performed in cooperation.

1. An examination appointment method to be used in an examination appointment system including a server installed in a data center, first terminals respectively installed in a plurality of examination request source medical institutions and connected to said server via a network, and second terminals respectively installed in a plurality of examination request destination medical institutions, which perform examinations intended for diagnosis in accordance with requests from said plurality of examination request source medical institutions and connected to said server via a network, said method comprising the steps of:
storing list data, in which selected examination request destination medical institutions and examination devices installed therein are associated with each others with respect to each of said plurality of examination request source medical institutions, in a first database by said server;
retrieving the list data associated with one of said plurality of examination request source medical institutions in the first database by said server when a list of examination devices installed in the examination request destination medical institutions selected by said examination request source medical institution is requested from a first terminal of said examination request source medical institution;
transmitting the retrieved list data from said server to said first terminal;
displaying in said first terminal the list of examination devices installed in the examination request destination medical institutions selected by said examination request source medical institution based on the received list data;
transmitting from said first terminal to said server information representing an examination request destination medical institution and an examination device designated in the displayed list of examination devices;
generating appointment status data in said server and transmitting the appointment status data to said first terminal, said appointment status data representing a calendar page including a plurality of appointment frames relating to appointment status of examinations employing the designated examination device in the designated examination request destination medical institution;
displaying the calendar page including the plurality of appointment frames based on the received appointment status data in said first terminal;
transmitting examination appointment information representing an appointment frame designated in the displayed calendar page from said first terminal to said server; and
making an examination appointment by storing the received examination appointment information in a second database by said server.

2. The examination appointment method according to claim 1, further comprising the steps of:
setting status information representing examination status by said server; and
displaying the examination status in said first terminal based on the status information set by said server after the examination appointment is made.

3. The examination appointment method according to claim 1, further comprising the steps of:
setting status information representing examination status by said server; and
controlling access to medical data resulting from an appointed examination based on the status information set by said server.

4. The examination appointment method according to claim 1, further comprising the steps of:
setting status information representing examination status by said server;
associating information representing location of stored relating medical data with patient attribute information by said server when the status information is changed; and
reading out the medical data based on the patient attribute information included in the examination appointment information in accordance with a request from said first terminal when the medical data is required.

5. An examination appointment system including a server installed in a data center, first terminals respectively installed in a plurality of examination request source medical institutions and connected to said server via a network, and second terminals respectively installed in a plurality of examination request destination medical institutions, which perform examinations intended for diagnosis in accordance with requests from said plurality of examination request source medical institutions, and connected to said server via a network, said system comprising:
a first terminal for making a request for a list of examination devices installed in the examination request destination medical institutions selected by one of said plurality of examination request source medical institutions to the server, displaying the list of examination devices installed in the examination request destination medical institutions selected by said examination request source medical institution based on the list data transmitted from said server, transmitting information representing an examination request destination medical institution and an examination device designated in the displayed list of examination devices to said server, displaying a calendar page including a plurality of appointment frames based on appointment status data transmitted from said server and transmitting examination appointment information representing an appointment frame designated in the displayed calendar page to said server; and
a server for storing list data, in which selected examination request destination medical institutions and examination devices installed therein are associated with each others with respect to each of said plurality of examination request source medical institutions, in a first database, transmitting to said first terminal, when a list of examination devices installed in the plurality of examination request destination medical institutions selected by the examination request source medical institution is requested from said first terminal, list data obtained by retrieving the list data associated with said examination request source medical institution in the first database, generating appointment status data representing a calendar page including a plurality of appointment frames relating to appointment status of examinations employing the designated examination device in the designated examination request destination medical institution to transmit the appointment status data to said first terminal, and making an examination appointment by storing the examination appointment information received from said first terminal in a second database.

6. The examination appointment system according to claim 5, wherein:
said server sets status information representing examination status; and
said first terminal displays the examination status based on the status information set by said server after the examination appointment is made.

7. The examination appointment system according to claim 5, wherein said server sets status information representing examination status, and controls access to medical data resulting from an appointed examination based on the set status information.

8. The examination appointment system according to claim 5, wherein said server sets status information representing examination status, associates information representing location of stored relating medical data with patient attribute information when the status information is changed, and reads out the medical data based on the patient attribute information included in the examination appointment information in accordance with a request from said first terminal when the medical data is required.

9. A server connected to first terminals respectively installed in a plurality of examination request source medical institutions and second terminals respectively installed in a plurality of examination request destination medical institutions, which perform examinations intended for diagnosis in accordance with requests from said plurality of examination request source medical institutions via a network, said server comprising:
storage control means for storing list data, in which selected examination request destination medical institutions and examination devices installed therein are associated with each others with respect to each of said plurality of examination request source medical institutions, in a first database;
retrieval control means for retrieving the list data associated with one of said plurality of examination request source medical institutions in the first database when a list of examination devices installed in the examination request destination medical institutions selected by said examination request source medical institution is requested from a first terminal of said examination request source medical institution;
transmission data generating means for generating appointment status data representing a calendar page including a plurality of appointment frames relating to appointment status of examinations employing the designated examination device in the designated examination request destination medical institution in the list of examination devices displayed in said first terminal; and
examination appointment managing means for making an examination appointment by storing examination appointment information in a second database, said examination appointment information representing an appointment frame designated in the calendar page displayed in said first terminal based on the appointment status data.

10. The server according to claim 9, wherein:
said examination appointment managing means sets status information representing examination status; and
said transmission data generating means generates appointment status data including the set status information so as to display the examination status in said first terminal based on the set status information after the examination appointment is made.

11. The server according to claim 9, wherein said examination appointment managing means sets status information representing examination status, and controls access to medical data resulting from an appointed examination based on the set status information.

12. The examination appointment system according to claim 9, wherein:
said examination appointment managing means sets status information representing examination status, and associates information representing location of stored relating medical data with patient attribute information when the status information is changed; and
said server further comprising a medical data managing unit for reading out the medical data based on the patient attribute information included in the examination appointment information in accordance with a request from said first terminal when the medical data is required.
